(19) United States
(12) Patent Application Publication
(10) Pub. No.: US 2022/0014374 A1
(43) Pub. Date: Jan. 13, 2022

(54) U2F PHYSICAL TOKEN-BASED CENTRALIZED AUTHENTICATION SYSTEM FOR IOT DEVICES

(71) Applicant: ZHEJIANG UNIVERSITY, Hangzhou City (CN)

(72) Inventors: Feng LIN, Hangzhou City (CN); Chao WANG, Hangzhou City (CN); Hao LUO, Hangzhou City (CN); Fan ZHANG, Hangzhou City (CN); Jinsong HAN, Hangzhou City (CN); Wenyao XU, Hangzhou City (CN); Kui REN, Hangzhou City (CN)

(21) Appl. No.: 17/483,815

(22) Filed: Sep. 24, 2021

Related U.S. Application Data
(63) Continuation of application No. PCT/CN2020/123038, filed on Oct. 23, 2020.

(30) Foreign Application Priority Data
May 20, 2020 (CN) 202010428749.1

(51) Int. Cl. H04L 9/32; H04L 9/08; H04L 29/08

(52) U.S. Cl. CPC H04L 9/3213; H04L 67/1097; H04L 9/0825; H04L 9/3247

(57) ABSTRACT

A physical token-based centralized authentication system for IoT devices is provided. The system transfers authentication of the IoT device on cloud to the IoT gateway for centralized authentication. User may respond on the IoT gateway via a U2F token to complete authentication of the IoT device. By transferring a kernel of authentication from a large number of scattered single IoT terminals to nodes of the trusted IoT gateway, the system overcomes defects such as numerous IoT devices, limited terminal resources, high authentication cost, and cumbersome operations while enhancing security of the IoT environment, thereby enhancing security of authentication for IoT environment and improving efficiencies of device authentication and management.

### CROSS-REFERENCE TO RELATED APPLICATIONS

The present application is a continuation of International Application No. PCT/CN2020/123038, filed on Oct. 23, 2020, which claims priority to Chinese Application No. 202010428749.1, filed on May 20, 2020, the contents of both of which are incorporated herein by reference in their entireties.

### TECHNICAL FIELD

The present disclosure relates to the field of computer networks technologies, and in particular, to a U2F token-based centralized authentication system for IOT (Internet of Things) devices.

### BACKGROUND

IoT (Internet of Things) has received more and more attention in recent years. From large-scale production device in factories to numerous household appliances, IoT has gradually penetrated into people's life. Various security issues occur while IoT is developing in full swing. In IoT, there are many problems and challenges in user's privacy, authorization, verification, access control, system configuration, information storage and management. Meanwhile, with exponential increase of IoT terminal devices, management and maintenance of many IoT devices have become a major problem.

Nowadays, U2F (universal two-factor) is mostly used in authentication scenarios with graphical interactive interfaces. However, various embedded devices of the IoT terminals often lack user interactive interfaces and thereby significantly constrain the application of U2F. Moreover, most of current two-factor authentication is end-to-end authentication. For IoT scenarios with numerous devices, authentication efficiency has become an urgent problem to be solved. At present, there is no solution for centralized authentication of IoT devices by using U2F tokens.

### SUMMARY

The present disclosure aims to provide a physical token-based centralized authentication system for IoT devices in view of deficiencies in the related art. By transferring a kernel of authentication from a large number of scattered single IoT terminals to nodes of the trusted IoT gateway, the system overcomes defects such as numerous IoT devices, limited terminal resources, high authentication cost, and cumbersome operations while enhancing security of the IoT environment, thereby enhancing security of authentication for IoT environment and improving efficiency of device authentication and management.

The proposal of the present invention is realized by the following technical solutions: a U2F token-based centralized authentication system for IoT devices, comprising: an IoT gateway, a U2F token, a U2F server, an IoT server and an IoT device.

The IoT gateway is configured to complete a forwarding operation of interactive data of the U2F token and cloud, and support communication between the IoT device and the IoT server.

The U2F token has a response button to access the IoT gateway and interact with the U2F server.

The U2F server communicates with the IoT gateway and responds to registration and authentication requests of the U2F token, and provides results of token registration and device authentication for the IoT server.

The IoT server interacts with the IoT device via the IoT gateway, and a user manages and maintains the IoT device via the IoT server.

The IoT device interacts with the IoT server via the IoT gateway, receives instructions from the IoT server and completes corresponding tasks.

Further, a U2F Host software module is integrated in the IoT gateway, the U2F Host software module is configured to forward data streams between the U2F token and the U2F server, and supports a USB interface.

The U2F token accesses the IoT gateway via the USB interface the U2F token comprises a physical button and an indicator light for response from the user, and the U2F token generates a key pair based on instructions from the U2F server and the response from the user, or uses an internally stored private key to perform an operation such as signing for data that is received.

Further, the IoT server has a user interaction interface, which is convenient for the user to manage and operate.

Further, a process of the token registration of the system is that: a user initiates a registration operation on the IoT server, and the IoT server informs the IoT gateway to initiate a registration request to the U2F server; the U2F server receives the registration request and sends a set of random numbers and U2F sever information to the IoT gateway, and the IoT gateway forwards the set of random numbers and the U2F sever information to the U2F token; the user interacts with the U2F token to generate a key pair and a Key Handle configured to identify the key pair, wherein a public key and the Key Handle are forwarded by the IoT gateway to the U2F server for storage, and a private key is stored in the U2F token and not capable of being read by an external device; and the U2F server receives and saves the public key and the Key Handle of the U2F token, and then sends a registration result to the IoT server.

Further, a process of the device authentication of the system is that: when the user attempts to perform a single operation or a certain series of operations on one or more IoT devices via the IoT server, the IoT server first notifies the IoT gateway to issue an authentication request to the U2F server; after receiving the authentication request, the U2F server sends a set of random numbers and U2F server information to the IoT gateway, and the IoT gateway forwards the set of random numbers and the U2F server information to the U2F token; the user interacts with the U2F token and uses the private key stored in the U2F token to perform a signing operation for data that is received, which is forwarded by the IoT gateway to the U2F server for signature verification; the U2F server uses the public key that is saved to verify the signature, and a verification result is returned to the IoT server; in response to the verification being successful, the IoT server responds to the operation initiated by the user on the IoT device; or in response to the verification being unsuccessful, the IoT server does not respond to the operation initiated by the user on the IoT device.

The present disclosure has following beneficial effects: based on interaction between the U2F token, the IoT gateway, the IoT device, the U2F server, and the IoT server, the present disclosure transfers authentication of the IoT device on cloud to the IoT gateway so as to realize centralized authentication of the IoT device. The user may complete authentication of all IoT devices under management via the IoT gateway, and the user only needs to respond via a button on the U2F token in the whole process. Operations are simple and fast, management efficiency of IoT devices is improved while security of device authentication under the IoT environment is enhanced. The proposed centralized authentication system does not require hardware changes to existing devices, so that hardware cost may be saved to the greatest extent, thereby having a good industrial application prospect.

### BRIEF DESCRIPTION OF DRAWINGS

FIG. 1 is a structural block diagram of a U2F token-based centralized authentication system for IoT devices according to an embodiment of the present disclosure.

FIG. 2 is a flowchart of token registration of a U2F token-based centralized authentication system for IoT devices according to an embodiment of the present disclosure.

FIG. 3 is a flowchart of device authentication of a U2F token-based centralized authentication system for IoT devices according to an embodiment of the present disclosure.

### DESCRIPTION OF EMBODIMENTS

Hereinafter, the present disclosure will be described in detail with reference to the drawings.

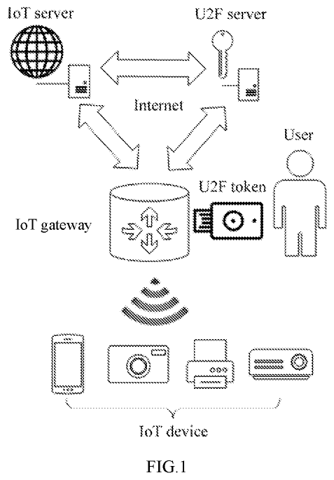

As shown in FIG. 1, the present invention mainly includes the following components: an IoT gateway, a U2F token, a U2F server, an IoT server, and IoT devices.

The IoT gateway is configured to complete a forwarding operation of the U2F token and cloud interactive data and to support communication between the IoT device and the IoT server.

The U2F token has a response button to access the IoT gateway and interact with the U2F server.

The U2F server communicates with the IoT gateway and responds to registration and authentication requests of the U2F token, and provides results of token registration and device authentication for the IoT server.

The IoT server interacts with the IoT device via the IoT gateway. The user manages and maintains the IoT device via the IoT server.

The IoT device interacts with the IoT server via the IoT gateway, receives instructions from the IoT server and completes corresponding tasks.

In the present disclosure, authentication of all IoT devices under management may be completed via the IoT gateway, and the user only needs to respond via the buttons on the U2F token in the whole process. Therefore, operation is simple and fast, and management efficiency of IoT devices is improved while device authentication security is enhanced under enhanced IoT environment. In addition, the centralized authentication system does not require hardware changes to existing device, which may save hardware costs to the greatest extent.

As a preferred embodiment, a U2F Host software module is integrated in the IoT gateway. The U2F Host software module is configured to forward data streams between the U2F token and the U2F server, and has a USB interface. The U2F token accesses to the IoT gateway via the USB interface. Meanwhile, it comprises a physical button and an indicator light for response from the users. The U2F token generates a key pair based on instructions from the U2F server and the response, or uses an internally stored private key to perform an operation such as signing for data that is received.

Herein, the indicator light adopts different colors to flash in different periods to indicate user's operations. For example, a flashing red light indicates that input is required, and a flashing green light indicates that input is completed, and so on.

In addition, the IoT server has a user interaction interface, which is convenient for users to operate and receive feedback.

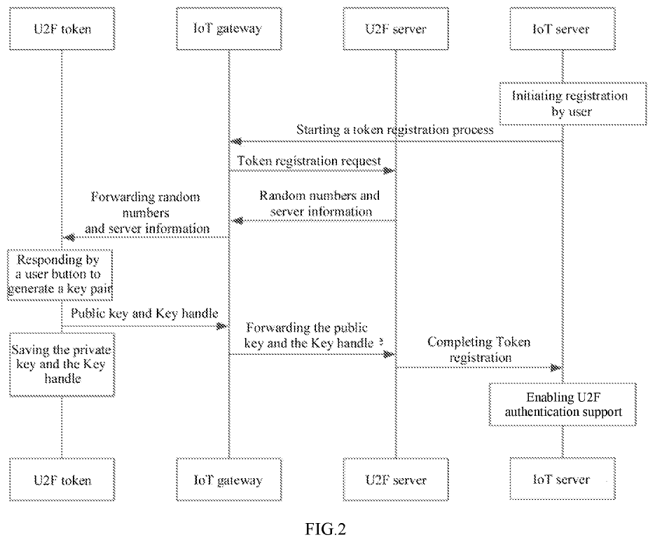

Before the U2F token may be normally used to authenticate the device, the user first needs to initiate a token registration operation on the IoT server. As shown in FIG. 2, a process of the token registration of the U2F token-based centralized authentication system for the IoT device according to the present disclosure is specifically as follow.

A user first needs to initiate a registration operation on an IoT server, and then the IoT server informs an IoT gateway to initiate a registration request to a U2F server. The U2F server receives the registration request and sends a set of random numbers and U2F server information to the IoT gateway, and the gateway forwards them to a U2F token. The user interacts with the U2F token (for example, pressing a button on the U2F token) to generate a key pair and a Key Handle configured to identify the key pair, wherein a public key and the Key Handle are forwarded by the IoT gateway to the U2F server for storage, and a private key is stored inside the U2F token and not capable to be read by an external device. The U2F server receives and saves the public key and the Key Handle of the U2F token, and then sends a registration result (success or failure) to the IoT server. Further, the user may be informed through a user interaction interface whether U2F authentication support has been turned on.

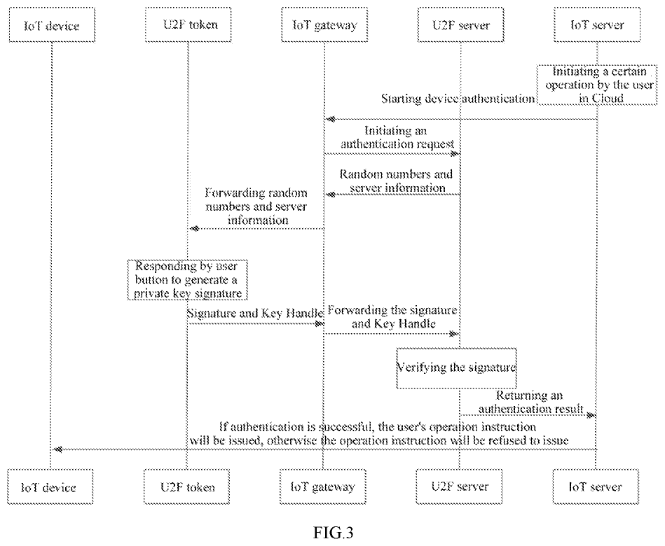

As shown in FIG. 3, a process of the device authentication of the physical token-based centralized authentication system for IoT devices according to the present disclosure is specifically as follows:

When a user attempts to perform a certain operation on an IoT device via an IoT server, a two-factor authentication process starts. The IoT server first notifies an IoT gateway to issue an authentication request to the U2F server. After receiving the request, a U2F server sends a set of random numbers and U2F server information to the IoT gateway, and the IoT gateway forwards the set of random numbers and the U2F server information to the U2F token. The user interacts with the U2F token (for example, pressing a button on the U2F token) and uses a private key to perform signing for data that is received, which is forwarded by the IoT gateway to the U2F server for signature verification. The U2F server uses the public key that is saved to verify the signature, and a verification result is returned to the IoT server. In response to the verification being sucessful, the IoT server responds to the operation initiated by the user on the IoT device, or in response to the verification being unsuccessful, it does not respond.

Finally, it should be noted that the above-listed are only specific embodiments of the present disclosure. The present disclosure is not limited to the above embodiments, but also has many possible variations. All modifications that may be directly derived or associated by those skilled in the art from the disclosure of the present disclosure should be considered within a protection scope of the present disclosure.

What is claimed is:

1. A Universal 2 Factor (U2F) token-based centralized authentication system for Internet of things (IoT) devices, comprising: an IoT gateway, a U2F token, a U2F server, an IoT server and an IoT device, wherein
the IoT gateway is configured to complete a forwarding operation of interactive data of the U2F token and cloud, and support communication between the IoT device and the IoT server;
the U2F token comprises a response button to access the IoT gateway and interact with the U2F server;
the U2F server communicates with the IoT gateway and responds to registration and authentication requests of the U2F token, and provides results of token registration and device authentication for the IoT server;
the IoT server interacts with the IoT device via the IoT gateway, and a user manages and maintains the IoT device via the IoT server;
the IoT device interacts with the IoT server via the IoT gateway, receives instructions from the IoT server, and completes corresponding tasks; and
a process of the token registration of the system is that:
a user initiates a registration operation on the IoT server, and the IoT server informs the IoT gateway to initiate a registration request to the U2F server;
the U2F server receives the registration request and sends a set of random numbers and U2F sever information to the IoT gateway, and the IoT gateway forwards the set of random numbers and the U2F sever information to the U2F token;
the user interacts with the U2F token to generate a key pair and a Key Handle configured to identify the key pair, wherein a public key and the Key Handle are forwarded by the IoT gateway to the U2F server for storage, and a private key is stored in the U2F token and not capable of being read by an external device; and
the U2F server receives and saves the public key and the Key Handle of the U2F token, and then sends a registration result to the IoT server.

2. The U2F token-based centralized authentication system for IoT devices according to claim 1, wherein a U2F Host software module is integrated in the IoT gateway; and the U2F Host software module is configured to forward data streams between the U2F token and the U2F server, and supports a USB interface; and
the U2F token accesses the IoT gateway via the USB interface, the U2F token comprises a physical button and an indicator light for response from the user, and the U2F token generates a key pair based on instructions from the U2F server and the response from the user, or uses an internally stored private key to perform a signing operation for data that is received.

3. The U2F token-based centralized authentication system for IoT devices according to claim 1, wherein the IoT server includes a user interaction interface.

4. The U2F token-based centralized authentication system for IoT devices according to claim 1 wherein a process of the device authentication of the system is that:
when the user attempts to perform a single operation or a series of operations on one or more IoT devices via the IoT server, the IoT server first notifies the IoT gateway to issue an authentication request to the U2F server;
after receiving the authentication request, the U2F server sends a set of random numbers and U2F server information to the IoT gateway, and the IoT gateway forwards the set of random numbers and the U2F server information to the U2F token;
the user interacts with the U2F token and uses the private key stored in the U2F token to perform a signing operation for data that is received, which is forwarded by the IoT gateway to the U2F server for signature verification;
the U2F server uses the public key that is saved to verify the signature, and a verification result is returned to the IoT server; and
in response to the verification being successful, the IoT server responds to the operation initiated by the user on the IoT device; or in response to the verification being unsuccessful, the IoT server does not respond to the operation initiated by the user on the IoT device.

5. The U2F token-based centralized authentication system for IoT devices according to claim 2 wherein a process of the device authentication of the system is that:
when the user attempts to perform a single operation or a series of operations on one or more IoT devices via the IoT server, the IoT server first notifies the IoT gateway to issue an authentication request to the U2F server;
after receiving the authentication request, the U2F server sends a set of random numbers and U2F server information to the IoT gateway, and the IoT gateway forwards the set of random numbers and the U2F server information to the U2F token;
the user interacts with the U2F token and uses the private key stored in the U2F token to perform a signing operation for data that is received, which is forwarded by the IoT gateway to the U2F server for signature verification;
the U2F server uses the public key that is saved to verify the signature, and a verification result is returned to the IoT server; and
in response to the verification being successful, the IoT server responds to the operation initiated by the user on the IoT device; or in response to the verification being unsuccessful, the IoT server does not respond to the operation initiated by the user on the IoT device.

6. The U2F token-based centralized authentication system for IoT devices according to claim 3 wherein a process of the device authentication of the system is that:
when the user attempts to perform a single operation or a series of operations on one or more IoT devices via the IoT server, the IoT server first notifies the IoT gateway to issue an authentication request to the U2F server;
after receiving the authentication request, the U2F server sends a set of random numbers and U2F server information to the IoT gateway, and the IoT gateway forwards the set of random numbers and the U2F server information to the U2F token;
the user interacts with the U2F token and uses the private key stored in the U2F token to perform a signing operation for data that is received, which is forwarded by the IoT gateway to the U2F server for signature verification;
the U2F server uses the public key that is saved to verify the signature, and a verification result is returned to the IoT server; and
in response to the verification being successful, the IoT server responds to the operation initiated by the user on the IoT device; or in response to the verification being unsuccessful, the IoT server does not respond to the operation initiated by the user on the IoT device.
